(19) United States
(12) Patent Application Publication
(10) Pub. No.: US 2026/0329606 A1
(43) Pub. Date: Oct. 22, 2026

(54) DISTRIBUTED VIDEO ENCODING IN A REMOTE DESKTOP ENVIRONMENT

(71) Applicant: Microsoft Technology Licensing, LLC, Redmond, WA (US)

(72) Inventor: Artem BELKINE, Woodinville, WA (US)

(21) Appl. No.: 19/185,632

(22) Filed: Apr. 22, 2025

(51) Int. Cl. G06F 9/451; G06T 1/20

(52) U.S. Cl. CPC G06F 9/452; G06T 1/20

(57) ABSTRACT

Methods, computer systems, and computer-storage media are provided for facilitating distributed encoding in a remote desktop environment. In embodiments, a representation of graphical data is provided to a first video encoder associated with a video driver of a remote desktop server. The first video encoder may encode the graphical data to generate base-encoded graphical data. Thereafter, a representation of the base-encoded graphical data is provided to a second video encoder associated with a remote access protocol stack in a terminal service of the remote desktop server. The second video encoder may encode the base-encoded graphical data to generate fully-encoded graphical data. Such fully-encoded graphical data is transmitted to a remote desktop client device.

### BACKGROUND

Remote desktop services enable users to access and control a remote computer or virtual machine from another device, providing a virtual desktop experience. Typically, a client device communicates with a remote desktop server via a terminal service using a remote desktop protocol (RDP) stack to facilitate communication. In conventional implementations, data may be encoded in association with a video driver before being provided to the RDP stack for transmission to the client device. Performing the data encoding process in association with a video driver and separated from the RDP stack, however, can result in an inefficient and ineffective architecture in some implementations, such as real-time and direct streaming implementations. For example, performing encoding in association with a video driver reduces opportunities to adjust encoding based on real-time network conditions. In such cases, video is compressed without context and cannot adapt to various conditions, such as bandwidth drops, spikes in latency, packet loss, congestion, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating distributed video encoding in a remote desktop environment. In particular, video encoding is performed in an efficient and effective manner that is distributed across components and stages at a remote desktop server. In this regard, a first portion of an encoding process, also referred to as a base encoding, may be performed in association with a video driver, while a second portion of the encoding process, also referred to as a final encoding, may be performed in association with the terminal service or RDP stack. For example, color conversion (and/or other preprocessing tasks) associated with an encoding process may be performed in association with the video driver, while video compression may be performed in association with the RDP stack. Performing a first portion of the encoding process, such as color conversion and/or other preprocessing tasks, at the video driver enables processing to be performed closer to the GPU and before data is passed to the RDP stack. Further, performing a second portion of the encoding process, such as video compression, at the RDP stack enables the system to be responsive and efficient to network context, particularly in real-time and streaming environments.

### BRIEF DESCRIPTION OF THE DRAWINGS

The technology described herein is described in detail below with reference to the attached drawing figures, wherein:

FIG. 1 is a block diagram illustrating an example operation of a remote desktop environment, suitable for use in implementing aspects of the technology described herein;

FIG. 2 provides an example remote desktop server that facilitates efficient and effective distributed encoding in a remote desktop environment, in accordance with aspects of the technology described herein;

FIG. 3 provides a first example method for facilitating distributed encoding in a remote desktop environment, in accordance with aspects of the technology described herein;

FIG. 4 provides a second example method for facilitating distributed encoding in a remote desktop environment, in accordance with aspects of the technology described herein;

FIG. 5 provides a third example method for facilitating distributed encoding in a remote desktop environment, in accordance with aspects of the technology described herein; and

FIG. 6 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Remote desktop services allow users to access and control a remote computer or virtual machine from another device. In this regard, users can connect to workstations, servers, or other computers remotely, thereby providing a virtual desktop experience. In this way, users can perform various tasks on a computing device as if physically present at the remote computer. Such various tasks may include, for example, running applications, accessing files, managing settings, and performing administrative tasks.

Generally, in conventional implementations, a client device includes a remote desktop application that is used to communicate with a remote desktop server via a terminal service executing at the remote desktop server. In establishing a connection between the remote desktop application of the client device and the terminal service of the remote desktop server, a remote desktop protocol (RDP) stack is initiated at the remote desktop server. In a remote desktop environment, RDP technology is utilized to enable efficient communication between the client device and the remote desktop server. The RDP stack facilitates the RDP communication between the client device and the remote desktop server. For example, the RDP stack can manage how data is packaged, transmitted, and/or received during remote desktop sessions. The RDP stack may also perform session management (e.g., authentication, encryption, and connection negotiation between the client device and the remote desktop server) and input/output management (e.g. transmission of user input from the client device to the remote desktop server and delivery of output from the remote desktop server to the client device).

In addition, in conventional implementations, the RDP stack of the remote desktop server may encode data to transmit to the client device. For example, the RDP stack may use various encoding techniques to encode graphical data prior to transmitting the data from the remote desktop server to the client device. In operation, a video driver obtains graphical data from an operating system of the remote desktop server. Such graphical data may include, for example, information about graphics, GUI elements, video data or content, or other graphical data to display at the client device. In accordance with obtaining data, such as graphical data, the video driver processes the data and generates the appropriate output for display at the client device. For example, the video driver may perform format conversion, scaling, color space conversion, and/or optimization for the target display (e.g., in accordance with capabilities and specifications of the client device). In this way, the video driver may interact with the operating system to generate graphical output based on instructions received from applications and/or the operating system. The processed graphical data may be provided or accessible to the RDP stack, which then encodes the data and transmits the encoded data to the client device during a remote desktop session. In particular, the video driver, in some cases along with the user mode remote desktop protocol (UMRDP), is responsible for providing the unencoded data to the terminal service and, in particular, the RDP stack of the remote desktop server for encoding.

Performing data encoding at the RDP stack, however, uses an extensive amount of CPU and memory resources. In particular, encoding data outside of the data acquisition process (also referred to as the driver process) results in CPU and memory resources being unnecessarily used to provide the raw data to the RDP stack of the terminal service. For example, a video driver may obtain megabytes of unencoded data, which is then passed to the RDP stack for encoding to compress the data before it is transmitted over the network to the client device. To provide the unencoded data to the RDP stack, the unencoded data is synchronized and copied between the video driver (or the data acquisition process) and the RDP stack (or the data transmission process). Synchronization and copying of data use an extensive amount of CPU and memory resources, particularly when raw data is synchronized and copied. Such an extensive use of CPU and memory resources to perform data synchronization and copying between the two processes to perform data encoding via the RDP stack is exacerbated as monitor resolutions increase. For example, High Dynamic Range (HDR) monitors have eight bytes per pixel, which is double the number of bytes per pixel of traditional monitors. As such, in instances in which HDR monitors are used, the amount of memory and CPU usage to provide the data to the RDP stack to perform the encoding process is doubled.

Because of the deficiencies of transmitting raw data from a video driver to a RDP stack for encoding, some conventional implementations perform data encoding in association with the video driver, as opposed to the RDP stack. As such, data encoding occurs in the same process as obtaining the unencoded (e.g., raw) data. In this way, rather than synchronizing and copying the unencoded data to the RDP stack for encoding before transmission to a client device, the unencoded data is obtained at the video driver and encoded in association therewith. The encoded data can then be provided to a terminal service, such as the RDP stack, for transmission to the client device. In such implementations, a video encoding manager and/or a video encoder(s) associated therewith is initialized exclusively in association with the video driver to perform the data encoding. As such, the encoding process, including color conversion and compression, are performed in association with the video driver prior to being communicated to the RDP stack.

Performing the data encoding process in association with a video driver, however, can result in an inefficient and ineffective architecture in some implementations, such as real-time and direct streaming implementations. Direct streaming, for example, may be used to deliver video content to a remote client without typical intermediate processing steps, such as desktop composition or re-encoding. As such, direct streaming may be used for high-performing scenarios, such as media playback or GPU-accelerated applications, in which latency and quality are critical. Accordingly, in such real-time and direct streaming implementations, among others, performing encoding using context associated with an RDP stack can facilitate a responsive encoding that adjusts to the context. In this way, encoding in association with a terminal service or RDP stack may enable dynamic, context aware encoding. As such, the encoding may be adjusted based on real-time network conditions. For example, based on real-time network conditions, bitrate adaptation, frame rate control, quality scaling, codec mode switching, latency-sensitive buffering, packetization strategy, and/or the like may be adapted. In cases in which encoding is separated from the RDP stack, the video would be compressed without context and would not adapt to various conditions such as bandwidth drops, spikes in latency, packet loss, congestion, and the like.

Further, performing encoding without context awareness of network conditions can result in unnecessary utilization of CPU, GPU, and memory resources. For example, in cases in which network congestion and/or low bandwidth is unrecognized, an encoder may continue to encode high-resolution and high bitrate video frames. In such a case, CPU and GPU cycles spent generating high-quality stream may be throttled, dropped, or buffered. Moreover, memory is used to hold larger frame buffers or compressed data that are not efficiently communicated. As another example, in cases in which an RDP stack is dropping frames due to congestion, an encoder may continue to produce new frames, thereby resulting in unnecessarily high CPU usage and memory pressure from queuing up unneeded frames.

Accordingly, embodiments described herein are directed to facilitating distributed video encoding in a remote desktop environment. In particular, video encoding is performed in an efficient and effective manner that is distributed across components and stages at a remote desktop server. In this regard, a first portion of an encoding process, also referred to as a base encoding, may be performed in association with a video driver, while a second portion of the encoding process, also referred to as a final encoding, may be performed in association with the terminal service or RDP stack. For example, color conversion (and/or other preprocessing tasks) associated with an encoding process may be performed in association with the video driver, while video compression may be performed in association with the RDP stack. Performing a first portion of the encoding process, such as color conversion and/or other preprocessing tasks, at the video driver enables processing to be performed closer to the GPU and before data is passed to the RDP stack. Further, performing a second portion of the encoding process, such as video compression, at the RDP stack enables the system to be responsive and efficient to network context, particularly in real-time and streaming environments.

To facilitate an efficient and effective distributed video encoding in a remote desktop environment, in some embodiments, a video encoding manager, and portions thereof, may be used across such multiple components and stages. In this way, a video encoding manager may be implemented in a modular manner in which such a manager may be unaware of the invoking and/or executing component. Accordingly, embodiments of this technology may use an architecture designed to use consistent interfaces and shared processing model(s) across different components and stages. Such an abstraction ensures that the video encoding manager operates independently of the calling context, such as whether it is running in association with the video driver or the RDP stack. Advantageously, a video encoding manager may adapt to performing the video encoding process in association with the video driver, in association with the RDP stack, or distributed between the video driver and the RDP stack.

In some embodiments, to facilitate an efficient and effective implementation, a representation of video data is shared or communicated to the RDP stack for subsequent processing. In particular, upon generating base-encoded data in association with a video driver, a representation of the base-encoded data, such as a reference or texture handle, is communicated. In this way, the base-encoded data may remain in the GPU and copying the entire base-encoded data from the GPU to system memory is avoided. A texture generally refers an array (e.g., two-dimensional) of pixel data generally residing in GPU memory. A texture may represent, for example, a rendered video frame, a snapshot of a window or application, a game surface, or any image used in GPU-based processing. A texture handle generally refers to a pointer or identifier to a resource that exists in the GPU. In this way, the actual video frame stays in GPU memory. As such, the RDP stack, or portion thereof (e.g., a video encoder) can access the texture directly via this handle and the base-encoded data need not be copied into a shared memory or user space.

In operation, upon initiating a first video encoding manager in association with a video driver and a second video encoding manager in association with a RDP stack, such video encoder managers may be used to facilitate distributed encoding of video data. In one example, the first video encoding manager associated with a video driver may use a first texture representing RGB video data (e.g., a frame in RGB format stored in GPU memory as a texture) to perform an initial stage of encoding, such as a color conversion from a RGB format to a YUV format, to generate base-encoded data. A second texture may represent the base-encoded data in the YUV format (e.g., stored in GPU memory). A reference or handle to the second texture may be provided to the RDP stack for performing a subsequent stage of encoding, such as video compression. In this way, the second texture may be referenced by the second video encoding manager associated with the RDP stack and, thereafter, compressed to generate fully-encoded data, which may then be provided to a client device.

Advantageously, performing data encoding in a distributed manner in association with a video driver and a RDP stack, as described herein, minimizes CPU and memory utilization. For example, context-aware encoding performed in association with the RDP stack enables a more efficient utilization of CPU and memory. Further, such context-aware encoding enables a higher quality encoding, which is particularly valuable in real-time or direct streaming implementations. In addition, communicating references to base-encoded data for subsequent encoding in association with the RDP reduces CPU and memory utilization that would otherwise be needed to copy the base-encoded data into shared memory.

### Overview of Exemplary Environments for Facilitating Distributed Video Encoding in a Remote Desktop Environment

As described, a user may desire to access computing applications remotely, e.g., applications that are running on a separate computing device. In this regard, a remote desktop environment or service may be used to provide a user with such access. A remote desktop environment or service includes a computer system that maintains applications that can be remotely executed by client computer systems. Input is entered at a client computer system and traversed over a network (e.g., using protocols based on the International Telecommunications Union (ITU) T.120 family of protocols such as RDP) to an application on a server, such as remote desktop server or terminal server. The application processes the input as if the input were entered at the server.

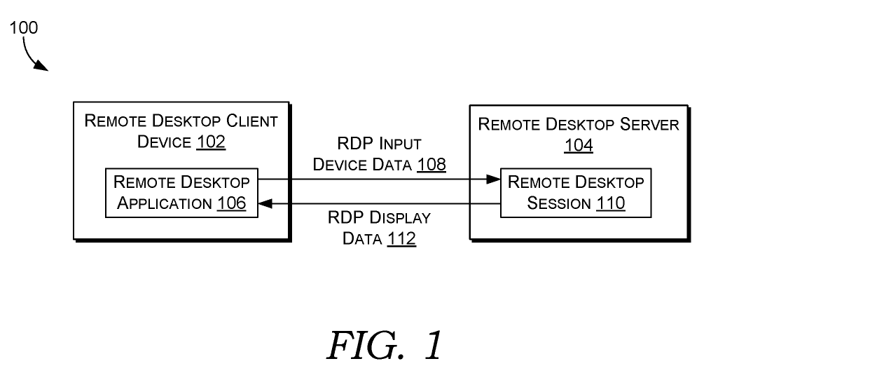

FIG. 1 provides a diagrammatic overview of the operation of a remote desktop environment 100. The remote desktop environment 100 includes a remote desktop client device 102 and a remote desktop server 104. Remote desktop client device 102 can be a client device on a client-side of remote desktop environment 100, while remote desktop server 104 can be on a server-side of remote desktop environment 100. Remote desktop server 104 may comprise server-side software designed to work in conjunction with client-side software on remote desktop client device 102 so as to implement any combination of the features and functionalities discussed in the present disclosure. The remote desktop environment 100 shown in FIG. 1 is an example of one suitable environment and is not intended to suggest any limitation as to the scope of use or functionality of embodiments disclosed throughout this document. Neither should the exemplary remote desktop environment 100 be interpreted as having any dependency or requirement related to any single component or combination of components illustrated therein. For example, any number of remote desktop client devices 102 and/or remote desktop servers 104 may exist within a remote desktop environment 100. For instance, multiple remote desktop client devices 102 may communicate with the remote desktop server 104.

A remote desktop client device 102 and a remote desktop server 104 can communicate through a network, which may include any number of networks, such as, for example, a local area network (LAN), a wide area network (WAN), the Internet, a cellular network, a peer-to-peer (P2P) network, a mobile network, or a combination of networks. In embodiments, the remote desktop client device 102 and the remote desktop server 104 communicate using RDP. Although illustrated and discussed as using RDP for communication, any remote access protocol may be used to enable the remote desktop client device 102 to connect to remote desktop server 104. Other examples of remote access protocol include, but are not limited to, Secure Shell (SSH), Virtual Network Computing (VNC), and TeamViewer.

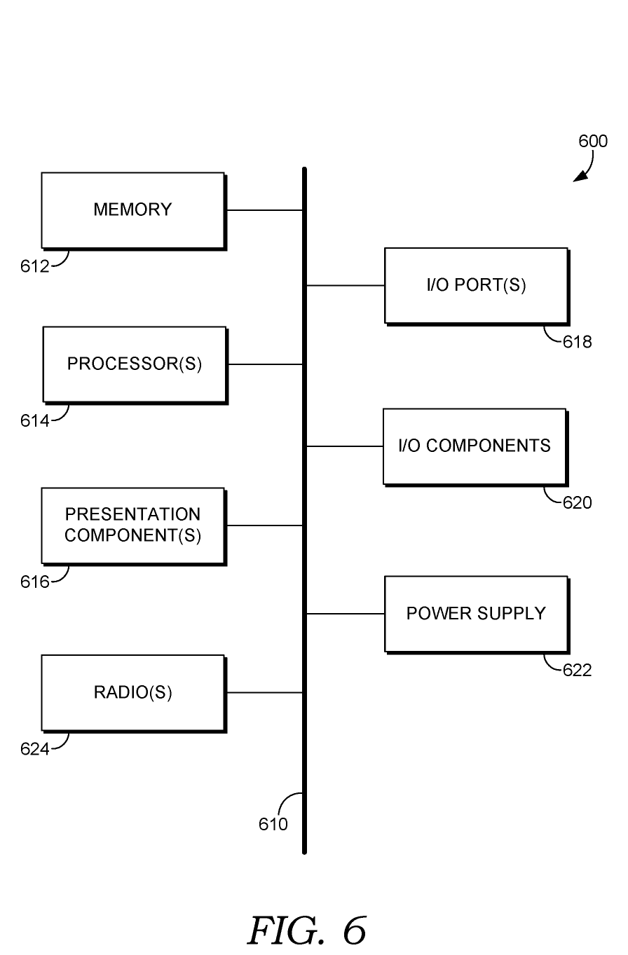

The remote desktop client device 102 can be any kind of computing device capable of facilitating a remote desktop session. For example, in an embodiment, the remote desktop client device 102 can be a computing device such as computing device 600, as described below with reference to FIG. 6. In embodiments, the remote desktop client device 102 can be a personal computer (PC), a laptop computer, a workstation, a mobile computing device, a PDA, a cell phone, or the like.

The remote desktop client device 102 can include one or more processors, and one or more computer-readable media. The computer-readable media may include computer-readable instructions executable by the one or more processors. The instructions may be embodied by one or more applications, such as remote desktop application 106 shown in FIG. 1. The application(s) may generally be any application capable of facilitating a remote desktop session(s). In some implementations, the application(s) comprises a web application, which can run in a web browser, and may be hosted at least partially server-side (e.g., via a server). In addition, or instead, the application(s) can comprise a dedicated application. In some cases, the application(s) is integrated into the operating system (e.g., as a service).

The remote desktop client device 102 is generally operated by an individual or entity that initiates a remote desktop session. In this way, an individual may desire to access and interact with a computer or desktop environment remotely (e.g., over a network connection). In a remote desktop session, a user’s inputs (e.g., mouse movements, keyboard inputs, touch gestures, and the like) are transmitted to the remote desktop server 104, and the graphical output of the remote desktop server 104 is provided to the remote desktop client device 102.

In operation, the remote desktop client device 102 runs a remote desktop application 106 that sends RDP input device data 108, such as for example, keyboard data and mouse click data, to a remote desktop session 110 that has been spawned in the remote desktop server and receives RDP display data 112, such as user interface graphical data. Generally, the remote desktop application 106 is a thin client process and most processing is provided on the remote desktop server 104.

When a remote desktop client device connects to a remote desktop server via a remote desktop server gateway (not shown), the gateway may open a socket connection with the remote desktop server and redirect client traffic on the RDP port or a port dedicated to remote access services. The gateway may also perform certain gateway specific exchanges with the client using a terminal servicer gateway protocol transmitted over HTTPS.

During the remote desktop session 110, an application running in the session generates output in response to the received input 108, and the output, or RDP display data, 112 is transferred over the network to the remote desktop client device 102. The remote desktop client device 102 runs a remote desktop application 106 that presents the output data. Thus, the input is received and output presented at the remote desktop client device 102, while processing occurs at the remote desktop server 104. A session can include a shell and a user interface such as a desktop, the subsystems that track mouse movement within the desktop, the subsystems that translate a mouse click on an icon into commands that effectuate an instance of a program, or the like. It should be understood that the foregoing discussion is exemplary and the presently disclosed embodiments may be implemented in various client/server environments and not limited to a particular remote desktop services product. One example of remote desktop system is Remote Desktop Services provided by Microsoft® Corporation.

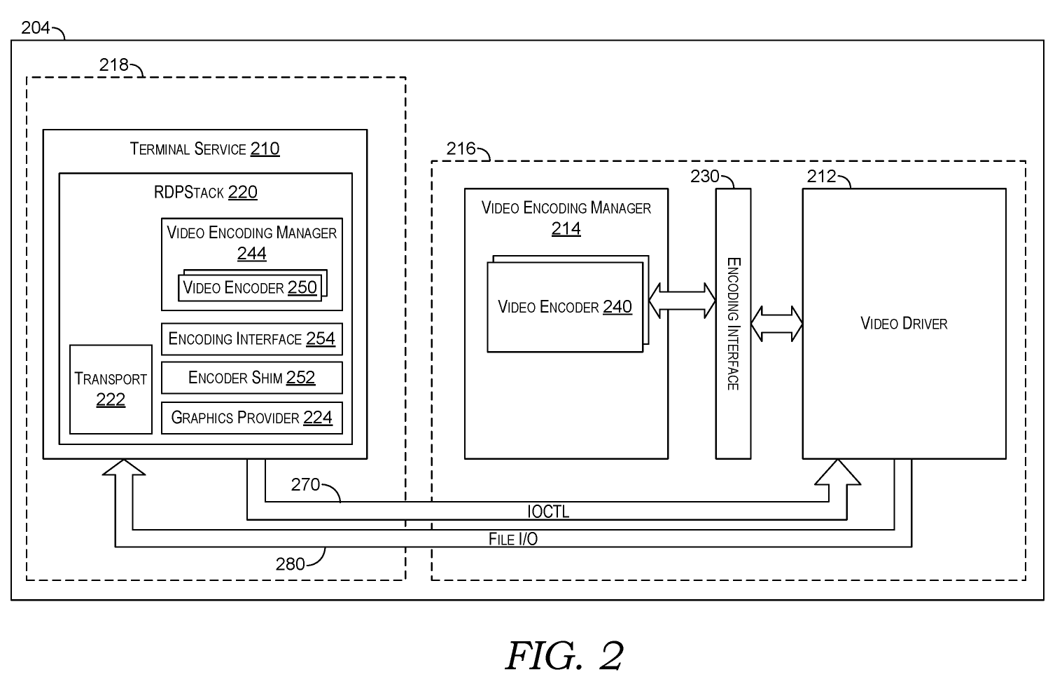

FIG. 2 provides an example remote desktop server that facilitates efficient and effective distributed data encoding. As illustrated in FIG. 2, the remote desktop server 204 facilitates graphical data encoding being performed in association with the session managing process 218 (e.g., terminal service 210) and the data acquisition process 216 (e.g., video driver 212). In particular, graphical data is encoded in a first manner in association with the video driver 212 (e.g., via the video encoding manager 214) before being communicated to the terminal service 210. In this way, a portion of an encoding process is performed in association with the data acquisition process 216 (or driver process), which is separate from the session managing process 218 (or RDP stack process). The data acquisition process 216 is generally configured to acquire graphical data, for example, via the operating system, application, and/or the like. Upon performing a first portion of an encoding process (e.g., color conversion) to generate base-encoded data, the base-encoded data, or a reference thereto, is provided to the terminal service 210 for performing a subsequent graphical data encoding in a second manner. As such, another portion of the encoding process is performed in association with the session managing process 218. The session managing process 218 is generally configured to manage remote desktop sessions, including performing user authentication, session creation, session management, and data transmission between a remote desktop client device and the remote desktop server 204 during remote desktop sessions. The session managing process 218 may operate at the application layer, while the data acquisition process 216 may operate at a different layer level (e.g., a lower level) than the session managing process. Performing graphical data encoding in association with the terminal service 210, or portion thereof, enables a more effective encoding (e.g., compression) that may adapt to context conditions.

In operation, a remote desktop client device may communicate with the remote desktop server 204 via a remote desktop application operating on the remote desktop client device. In particular, the remote desktop client device, via the remote desktop application (e.g., remote desktop application 106 of FIG. 1), may connect with the terminal service 210 running on the remote desktop server 204. In this regard, the remote desktop application may initiate and communicate a connection request to initiate a remote desktop session. A connection request may be initiated in a number of ways. For example, in some cases, a connection request may be initiated based on the remote desktop application (e.g., 106 of FIG. 1) being launched. In other cases, a connection request may be initiated based on a user selection via the remote desktop application. In some cases, in accordance with initiating the connection request, communication between the remote desktop client device (e.g., 102 of FIG. 1) and the remote desktop server 204 may be exchanged to perform authentication (e.g., verifying username and password of user), among other things.

In accordance with a successful authentication, a connection is established between the remote desktop client device and the remote desktop server 204. Establishing a connection may include, for example, negotiating protocol versions, security settings, and/or other parameters to ensure a stable and secure connection between the remote desktop client device and the remote desktop server 204. For example, the remote desktop client device and the remote desktop server 204 may negotiate connection parameters and establish a secure communication channel using the RDP that encrypts the data exchanged between the remote desktop client device and the remote desktop server 204. Upon establishing the connection, the terminal service 210 may facilitate initiating a new remote desktop session for the authenticated user. Initializing a remote desktop session may include setting up the user’s desktop environment, preparing the display, and/or loading necessary resources for the remote desktop session.

In accordance with initializing the remote desktop session, graphical data can be rendered for display on the remote desktop client device. In this regard, and at a high level, graphical output generated by applications running on the remote desktop server are captured and encoded for transmission to the remote desktop client device. The remote desktop client device receives the encoded graphical data and renders it on the local display. In this way, the user may be provided with control over the remote desktop, which is now an active remote desktop session within the operating system. The user can interact with the desktop environment, launch applications, access files, and perform tasks as if the user was physically present at the remote desktop server 204. In accordance with such interactions, the remote desktop client device may provide or transmit GUI elements, keyboard input, mouse movements, and/or other user interactions between the client device and remote server.

With respect to the remote desktop server 204, the remote desktop server 204 includes a terminal service 210, a video driver 212, and a video encoding manager 214. As shown, the terminal service 210 corresponds with the session managing process 218, which is generally configured to manage remote desktop sessions including performing user authentication, session creation, session management, and data transmission between the client and server during remote desktop sessions. The video driver 212 and the video encoding manager 214 correspond with the data acquisition process 216, which is generally configured to manage data acquisition (e.g., acquire data). In accordance with embodiments described herein, data encoding may be performed using the video encoding manager 244 in association with the terminal service 210 and the video encoding manager 214 in association with the video driver 212. In this regard, both the data acquisition process 216 and the session managing process 218 include encoding graphical data in a distributed and sequential manner before the data is communicated to the remote desktop client device.

The terminal service 210 communicates with the remote desktop client device (e.g., remote desktop client device 102 of FIG. 1) and manages remote desktop sessions. A remote desktop session generally refers to a time period during which a user accesses and interacts with a remote desktop environment or applications on a remote computer from a client or local device. As can be appreciated, the terminal service 210 can manage multiple remote desktop sessions, for example, associated with multiple users.

The terminal service 210 includes an RDP stack 220, which may be loaded therein. The RDP stack 220 includes software components and protocols that implement and/or manage communication between a remote desktop client device and the remote desktop server 204 (e.g., using RDP). Although illustrated as an RDP stack, a remote access protocol stack of any configuration may be used.

The RDP stack 220 may be loaded at any time. In one embodiment, the RDP stack 220 is loaded when a connection request is obtained, for instance, when a user attempts to initiate a remote desktop session. In another embodiment, the RDP stack 220 is loaded when the terminal service 210 is loaded. For example, when the remote desktop server 204 boots and loads the core operating system, the terminal service 210 and the RDP stack 220 may be initiated or loaded. In accordance with initializing the RDP stack 220, it listens for incoming data, such as connection requests, for example, from a remote desktop client device(s) and manages the communication between a remote desktop client device(s) and the remote desktop server 204. For instance, in association with a connection request, the RDP stack 220 may perform various tasks, such as authentication and session management. Once negotiation is successful and the connection is established, the RDP stack facilitates data transport between the remote desktop client device and the remote desktop server 204. For example, the RDP stack 220 may interact with the video driver 212 to transmit graphical data from the virtual desktop to the display of the remote desktop client device.

In some embodiments, the RDP stack 220 may include a transport 222 and a graphics provider 224. The transport 222 and/or graphics provider 224 may be initiated or instantiated at any time. As one example, transport 222 and/or graphics provider 224 may be initiated in accordance with activation or initiation of the RDP stack 220 and/or a remote desktop session. For example, assume a user initiates a connection request to connect with the remote desktop server 204. In such a case, the RDP stack 220 may be initiated at the remote desktop server 204 when the remote desktop client device communicates a connection request. In this way, when a remote desktop client device initiates a connection to the remote desktop server 204, the RDP stack 220 may become active to handle the incoming connection request. As part of such an activation, the transport 222 and/or graphics provider 224 may be initialized.

The transport 222 is generally configured to manage data communication between a remote desktop client device and the remote desktop server 204. In this regard, when a remote desktop session is initiated (e.g., a user initiates a remote desktop session), the transport 222 manages communication, or data packet flow, between the remote desktop client device and the remote desktop server 204. The transport 222 may perform various tasks, such as packetization, encryption, compression, and/or ensuring reliable delivery of data (e.g., via packet acknowledgments, retransmissions, and/or flow control). The transport 222 can package the remote desktop protocol onto the underlying network protocol, such as Transmission Control Protocol (TCP) or User Datagram Protocol (UDP), for communication.

The graphics provider 224 is generally configured to facilitate display of graphical content on the remote desktop client device during a remote desktop session(s). In some cases, the graphics provider 224 may be a Universal Windows Platform Remote Desktop Protocol (UMRDP) graphics provider. In some embodiments, the graphics provider 224 may obtain graphical data for transmitting to the remote desktop client device. For example, and as described herein, base-encoded graphical data may be provided to the graphics provider 224 (e.g., from a video encoder 240 of the video encoding manager 214). In cases in which the graphics provider 224 obtains base-encoded graphical data, the graphics provider 224 may facilitate a final encoding of the data for transmission over the network, as described in more detail below. In this way, the graphics provider 224 may manage efficient transmission of graphical data, such as screen updates, images, and video, between a remote desktop client device and the remote desktop server 204.

As described, the terminal service 210 manages remote desktop sessions. In particular, the terminal service 210 may initiate a remote desktop session upon obtaining or receiving a connection request and/or establishing a connection. For example, in obtaining a connection request, the terminal service 210 may instruct the operating system of the remote desktop server 204 to initiate or start a remote desktop session (e.g., upon authentication). As such, the operating system of the remote desktop server 204 can initiate a remote desktop session in response to such an instruction from the terminal service 210. In initiating a remote desktop session, a video driver 212 is activated (e.g., via the operating system). The video driver 212 may interact with the operating system and capture the graphics or video output associated with the remote desktop session. In this regard, in initiating a remote desktop session, a video driver is activated to capture graphical information, which can be transmitted back to the client via the terminal service 210.

In accordance with initiating a remote desktop session, the remote desktop server 204 may obtain various data (e.g., associated with graphics capabilities) from a remote desktop client device to facilitate the remote desktop session. As one example, monitor configuration data may be obtained. The remote desktop server (e.g., via the graphics provider 224) may obtain such data and use such data to facilitate a remote desktop session. For example, the terminal service 210 may communicate monitor configuration data to the video driver 212. For instance, the RDP stack 220 (e.g., via the graphics provider 224) may communicate the monitor configuration data (e.g., obtained from a remote desktop client device) to the video driver 212. In some cases, the monitor configuration data is provided to the video driver 212 via input/output control (IOCTL) 270.

As another example, the remote desktop server 204 may obtain an indication of an encoding library. In some cases, an encoding library may be a dynamic link library (DLL), which may refer to a file format that stores shared code and resources that can be loaded by multiple programs or system components. Generally, in a remote desktop protocol environment, the encoding library identified is typically an RDP Advanced Video Encoder, which may be referred to as RdpAvenc DLL. An RdpAvenc DLL may be a compiled binary file that contains functions, classes, and/or APIs for encoding audio and/or video during RDP sessions.

As another example, the remote desktop server 204 may obtain an environment context indicator. An environment context indicator may indicate an applicable environment or context for an RDP session. As one example, an environment context indicator may indicate a direct stream environment. A direct stream may indicate that media (e.g., audio/video) is streamed directly to the client using a specialized protocol or encoder. In some cases, an environment context identifier may include or indicate a specific encoder(s) to use for encoding data. Alternatively or additionally to providing an environment context identifier, an indication to use a distributed encoding implementation may be obtained.

The remote desktop server 204, for example, via the graphics provider 224, may use such data (e.g., the encoding library indicator and/or the environment context indicator) to facilitate the remote desktop session. For example, the terminal service 210 may provide an encoding indicator to the video driver. As used herein, an encoding indicator generally indicates or provides an instruction related to graphical data encoding. An encoding indicator may include a video encoding manager identifier, an encoder library identifier, and/or a video encoder identifier. In embodiments, the terminal service 210 may provide (e.g., via the RDP stack) the encoding indicator to the video driver via IOCTL. In this way, an IOCTL interface 270 may be used to communicate with the video driver. The encoding indicator may instruct the video driver to load or utilize a particular video encoding manager, encoding library, and/or video encoder (e.g., using a video encoding manager identifier, an encoding library identifier, and/or a video encoder identifier, respectively). Although described as a single encoding indicator including various data, different or multiple encoding indicators may be communicated to convey different types of information.

The particular video encoding manager, encoding library, and/or video encoder(s) to provide in association with an encoding indicator may be identified or determined in any number of ways. In some cases, a video encoding manager, encoding library, and/or video encoder identifier may be provided by the remote desktop client device. For example, the remote desktop client device, the remote desktop client application, and/or the user may indicate or specify a particular video encoding manager identifier, encoding library, and/or video encoder to use. For example, as described above, an indication of an encoding library may be provided by the remote desktop client device. Alternatively or additionally, the remote desktop server (e.g., via the terminal service 220) may determine a particular video encoding manager, encoding library, and/or video encoder(s). For example, a video encoder(s) may be determined based on an environment context indicator. For instance, in a direct streaming environment or other environment in which distributed encoding is desirable or advantageous, a particular preprocessing encoder(s), such as a color-conversion encoder, may be specified for use. As another example, a particular video encoding manager, encoding library, and/or video encoder(s) may be based on the type of remote desktop client device (or attributes associated therewith, such as resolution of the monitor), the type of data, the user, computational efficiency of the video encoder, and/or any other attribute or factor.

As described, the encoding indicator may be provided to the video driver 212 via IOCTL 270. In accordance with embodiments described herein, the encoding indicator may indicate to load a color-conversion encoder (e.g., to convert RGB to YUV) in association with a video encoding manager. In some cases, an environment context indicator may be provided to the video driver 212 and/or the video encoder manager 214, which may then use such information to load a particular encoder, such as a color-conversion encoder to convert graphical data from a first color format or color space to a second color format or color space.

In addition to configuring encoding to be performed in association with the video driver 212 (e.g., via video encoding manager 214), video encoding may also be configured for performing in association with the RDP stack 220. As such, the RDP stack 220, for example via the graphics provider 224, may determine to load a video encoding manager 244 in association with the RDP stack 220 to perform encoding at the RDP stack 220. For example, in accordance with obtaining an environment context indicator, the graphics provider 224 may determine to load a video encoding manager 244 in association with the RDP stack 220. Based on the indication of the encoding library, such as RdpAvenc DLL, the corresponding library may be dynamically loaded, if not already loaded. In this way, a video encoding manager(s) 224 may be initiated and the specified encoding library loaded for performing encoding.

In association with the environment context indicator, the terminal service 210, via the RDP stack 220 (e.g., the graphics provider 224) may initiate loading of an encoder shim 252. For example, based on an environment context, such as a direct streaming environment, encoder shim 252 may be loaded or instantiated. In accordance with loading the encoder shim 252, the encoder shim 252 may initiate loading of the encoding interface 254, the video encoding manager 244, and/or video encoder 250 in association with the RDP stack. The encoder shim 252, which is described in further detail below, generally provides translation between the graphics provider 224 and the encoding interface 254 and/or video encoding manage 244. At a high level, the encoder shim 252 functionally resembles a driver to which the video encoding manager 244 can plug in and that can provide data to the video encoding manager 244.

As described, the data acquisition process 216 generally performs data acquisition. That is, the data acquisition process 216 may obtain graphical data and provide graphical output (e.g., images or visual outputs) that can be displayed on a display screen. In accordance with embodiments described herein, the data acquisition process 216 is performed using the video driver 212 and the video encoding manager 214. At a high-level, the video driver 212 obtains graphical data and performs graphics processing, and the video encoding manager 214 manages encoding of the graphical data, such as performing base-encoding of the graphical data.

The video driver 212 is generally configured to obtain graphical data and, in some cases, process such data. To do so, the video driver 212 may communicate with the operating system and the graphics hardware (e.g., GPU) to manage graphics rendering and display management. In this way, the video driver 212 may facilitate communication between software and the display hardware. In some embodiments, the video driver 212 facilitates rendering of visual content (e.g., images) for display on the screen. As such, the video driver 212 may translate high-level graphics commands into instructions that the GPU or CPU can understand and execute. Such instructions may relate to colors, positions, transformations, layout details, or the like. In this way, the video driver 212 may communicate or interface with a graphics subsystem (e.g., GPU and/or CPU), which performs the rendering, to ensure correct display on monitors. For example, the GPU may process the rendering instructions provided by the video driver and generate actual pixel data for the final image. Such data may include the rendered frame, which includes pixel values representing color, depth information, and any additional rendering effects applied during the process (e.g., lighting, shadows, anti-aliasing). The rendered frame is the visual output of the rendering process, representing what the user may view on the screen. The rendered data (e.g., frame(s)) can then be returned to the video driver 212 for processing and/or communicating, for example, to the video encoding manger 214. For example, the video driver may take the rendered frame data (e.g., via a frame buffer) and prepare it for display (e.g., performing color space conversion, scaling, gramma correction, and/or other adjustments to ensure compatibility with the display hardware and settings). The graphical data (e.g., in the form of the rendered output or data processed therefrom) may then be communicated from the video driver. The video driver 212 may perform various functionalities, such as, for example, creating the graphics adapter representing the indirect display device; reporting connected and disconnected monitors; providing descriptions of connected monitors and available display modes; supporting other display functionality like hardware mouse cursor, gamma, I2C communications, and protected content; handling the desktop image processing for display; and implementing UMDF functionality such as device communications, power management, and plug-and-play.

In one embodiment, the video driver 212 is in the form of an indirect display driver (IDD) or a remote desktop protocol indirect display driver (also referred to as RDPIDD). An IDD or RDPIDD is generally implemented in cases in which monitors are indirectly connected. An IDD is used when rendering occurs indirectly, such as when using remote desktop services. In particular, graphics rendering occurs at the remote desktop server, but the output is displayed on a local remote desktop client device. An IDD or an RDPIDD may serve as a user-mode driver for the indirect display device. In embodiments, an IDD or RDPIDD may create a graphics adapter representation for the indirect display, report connected and disconnected monitors, provide monitor descriptions and available display modes, or the like.

In some cases, a video driver 212 in the form of an RDPIDD operates within the framework provided by a Windows Device Driver Model (WDDM). Stated differently, the RDPIDD is a subsystem of the WDDM. The WDDM provides a standardized interface between display drivers (e.g., user-mode device drivers) and the operating system. In some cases, a video driver 212, such as an RDPIDD, is implemented via a public API (e.g., Independent Display Driver for Console Extensions (IDDcx)).

In some embodiments, a video driver 212 is initiated or loaded via a user-mode driver framework (UMDF). In this regard, the video driver 212 may be referred to as a user-mode driver or UMDF driver. UMDF is a framework for developing user-mode drivers in a Windows operating system. User-mode drivers run in user space rather than kernel space. In some cases, when a device requires the UMDF driver to be connected to the system, the plug-and-play subsystem of the operating system detects the device and identifies the corresponding or appropriate driver package. The plug-and-play subsystem can then initiate the device installation process. During the device installation process, the driver may be loaded into memory (e.g., via a UMDF loader component of the operating system). For example, the plug-and-play system may load or launch a Windows Graphic Foundation (WGF) host executable, which includes the video driver to initiate, download, or install. Once loaded into memory, the video driver is initialized, which may include executing the driver’s entry point and initializing any data structures, resources, or runtime environments required by the video driver to function properly.

In accordance with embodiments herein, the video driver 212 obtains unencoded (e.g., raw) graphical data (e.g., rendered data). In some embodiments, unencoded graphical data is obtained from the operating system of the remote desktop server 204. The video driver 212 may capture unencoded graphical data from the operating system for a particular session. For example, for a user at a remote desktop client device, the operating system provides data to the video driver 212 in association with the particular remote desktop session associated with the user. In some cases, the video driver 212 obtains unencoded graphical data by intercepting graphical data generated or output by applications running on the remote desktop server’s environment. Such graphical data may include windows, icons, dialog boxes, and/or any other graphical element produced by applications. In some cases, the video driver 212 is also configured to manage various display-related tasks within the remote desktop session. For example, the video driver 212 may manage tasks such as screen resizing, color depth adjustments, and cursor handling.

In accordance with embodiments described herein, the video driver 212 communicates with the video encoding manager 214, or portion thereof (e.g., a video encoder), to facilitate graphical data encoding. In particular, the video driver 212 may provide the unencoded graphical data, or a representation thereof, to the video encoding manager 214. Video encoding refers to the process of encoding graphical data, including video as well as other visual elements displayed in association with a remote desktop. For example, video encoding may include encoding various types of graphical data generated by applications running on the remote desktop server, such as text, images, icons, videos, windows, and other visual elements.

In some cases, the video driver 212 identifies or determines a video encoding manager 214 and/or video encoder 240 with which to communicate. In this regard, the video driver 212 may identify which video encoder manager 214 and/or video encoder 240 to provide graphical data for encoding. For example, in some cases, multiple video encoding managers 214 may exist (e.g., for different remote desktop sessions or for different users). As another example, multiple video encoders may exist in association with a video encoding manager (e.g., to perform different encoding techniques). A particular video encoding manager 214 and/or video encoder 240 may be identified in association with the video driver 212. For example, the video driver 212 may have a video encoding manager identifier and/or video encoder identifier hard coded to indicate a desired video encoder manager and/or video encoder. In other examples, an encoding indicator may be received or obtained at the video driver 212 indicating a desired video encoding manager and/or video encoder. For instance, an encoding indicator may be generated and/or provided from the terminal service 210 (e.g., based on an instruction from a remote desktop client device or based on identifiers hard-coded in association with the terminal service or RDP stack) to the video driver 212 indicating a video encoding manager identifier and/or a video encoder identifier for use in performing graphical data encoding. A video encoding manager identifier provides an identification or indication of a particular video encoding manager to load and/or utilize, for example, in association with a remote desktop session. A video encoder identifier provides an identification or indication of a particular video encoder to load and/or utilize, for example, in association with a remote desktop session. In some examples, the encoding indicator is provided from the terminal service 210 via IOCTL 270. Based on the encoding indicator, the video driver 212 may communicate or direct graphical data accordingly. In some cases, upon the video driver obtaining the encoding indicator (e.g., via IOCTL at the beginning of a remote desktop session), the video driver 212 may initiate loading of the desired video encoding manager 214 and instantiate the desired video encoder 240.

To communicate with the video encoding manager 214, in some cases, the video driver 212 communicates via an interface, such as encoding interface 230. Encoding interface 230 facilitates a logical separation between video driver 212 and the video encoding manager 214, and tasks associated therewith. In some cases, the encoding interface 230 packages the graphical data obtained from the operating system in a different manner that is suitable to the video encoding manager 214, and/or video encoder(s) 240 associated therewith.

In some cases, the video driver 212 communicates graphical data to the video encoding manager 214, or a portion thereof (e.g., video encoder 240). In such a case, the graphical data may be encoded via video encoder 240. In other cases, the video driver 212 communicates an indication of graphical data to the video encoding manager 214, or a portion thereof. An indication of graphical data may be a reference or handle to a texture. A texture may refer to a block of image or pixel data that is used by a GPU during rendering or processing. A texture may represent graphical data, such as a frame of display or video. In embodiments, a texture may be a structured memory resource optimized for high-speed access. Textures may be stored in GPU memory or system memory, for example. Textures can be shared between processing using shared handles, thereby allowing encoders, display drivers, etc. to access without copying the data.

Video encoding manager 214 is generally configured to manage graphical data encoding, such as graphical data encoding performed by one or more of video encoders 240. In accordance with embodiments described herein, a base encoding, or initial encoding, may occur at the video encoding manager 214. At a high-level, the video encoding manager 214, and/or a video encoder(s) associated therewith, obtains unencoded graphical data (e.g., raw frames), or a reference thereto, and applies an encoding technique to encode the graphical data for more efficient transmission to a remote desktop client device.

As described, the video encoding manager 214 and/or video encoder(s) 240 may be initiated in any of a number of ways. In some cases, the video encoding manager 214 and/or video encoders 240 are initiated in conjunction with initiation of the video driver 212. For example, in association with a plug-and-play identifying to initiate the video driver 212, the video encoding manager 214 and/or video encoder(s) 240 may also be initiated or loaded. As one example, based on a plug-and-play detecting a display device and identifying to initiate the video driver 212, the Windows Display Driver Model (WDDM) may manage display-related tasks, including loading (e.g., into memory) the video driver 212, the video encoding manager 214, and/or a video encoder(s) 240. In other cases, the video driver 212 (e.g., upon being initiated) may initiate or load the video encoding manager 214 and/or a video encoder(s) 240. For instance, based on an encoding indicator (e.g., including a video encoding manager identifier and/or a video encoder identifier) obtained from the terminal service 210 (via an IOCTL interface), the designated video encoding manager and/or video encoder may be initiated or loaded. By way of example, based on a video streaming context environment, the video driver 212 may identify that color-conversion encoding is desired to be performed in association with an encoder 240. As such, the encoder 240, in the form of a color-conversion encoder, can be loaded or instantiated and graphical data provided thereto or accessed for encoding.

In some cases, the video encoding manager 214 may be in the form of, or based on, a DLL. A DLL refers to a file format, which may be used to hold multiple codes and procedures. A DLL allows for code to be shared among different programs, which can reduce disk space and memory usage. Further, a DLL may facilitate a more efficient management and updating of code. Using a DLL that is logically separated from the video driver, or DLL associated therewith, facilitates development of software (e.g., third-party software) that extends or enhances the encoding functionality without requiring modifications to the core video driver itself. As such, a DLL associated with a video driver 212 and a DLL associated with a video encoding manager 214 may be logically separate.

In some cases, the video encoding manager 214 may determine or select a video encoder 240 to use. For example, the video encoding manager 214 may include various video encoders 240. A video encoding manager 214 may implement, include, or use any number or type of video encoders (e.g., as needed or suitable to a desired implementation). In some cases, the video encoding manager 214 may implement a single video encoder at a single point in time. In this way, only a single video encoder is active at a single point in time. As such, the video encoding manager 214 may load and/or unload a video encoder(s) as needed.

A video encoder, such as video encoder 240, generally refers to a component that performs encoding of graphical data. In this way, a video encoder may convert graphical data from one format to another, for example, to facilitate storage or transmission. By incorporating a video encoder(s) into a video encoding manager (e.g., a DLL), a developer can modularize the encoding functionality making it easier to manage and integrate into different software applications.

As described herein, a video encoder 240 operating at video encoder manager 214 in association with the video driver 212 may perform a base encoding or initial encoding. In this way, a portion of data encoding may occur in association with the video driver. A base encoding may be any encoding that occurs prior to a subsequent encoding. In some cases, a base encoding includes encoding processes that are performed prior to performing data compression. As one example, a base encoding may be color-conversion encoding that converts data from one color format or color space to another color format or color space. One example of color-conversion encoding is encoding data from a RGB color format to a YUV color format. RGB refers to a red, green, and blue color model used to represent and display digital color by combining different intensities of such colors. YUV is a color space, with Y representing luminance or brightness, and U and V representing chrominance (color info). YUV is efficient for compression as the human eye is more sensitive to brightness than color, color resolution (subsampling) can be reduced and bandwidth saved. As such, instead of sending raw RGB data (which is large), a color-conversion encoder in association with the video driver may be used to convert to a YUV color format, for example, in a format such as YUV420 or YUV444.

A video encoder 240 may perform encoding in a particular manner, and color-conversion encoder is provided as one example. As such, various video encoders 240 may perform different techniques or manners of encoding graphical data.

The video encoder 240 encodes graphical data, such as graphical data obtained or output by video driver 212. For example, the video driver 212 may obtain and/or generate graphical output, such as images, GUI elements, and text rendered in specific fonts, understandable by the graphics hardware. As described, such graphical data may be provided to the video encoder for encoding. Alternatively or additionally, an indication of such graphical data may be provided to the video encoder such that the video encoder may access the graphical data (e.g., via a texture).

In accordance with performance base encoding of graphical data, in some cases, the base-encoded graphical data is communicated to the terminal service 210. In particular, the base-encoded graphical data may be communicated to the RDP stack 220 of the terminal service 210. The base-encoded graphical data may be communicated to the RDP stack 220 of the terminal service 210 in a number of ways. In one embodiment, the base-encoded graphical data is provided to the video driver 212 for providing to the RDP stack 220. As one example, the video driver 212 may communicate the base-encoded graphical data using File Input/Output (File I/O) 280. File I/O generally refers to the process of reading from and writing to files on a computer’s storage system (e.g., in an asynchronous manner). File I/O may be used to extract base-encoded graphical data (e.g., frames). In some cases, File I/O opens a channel directly to the video driver, providing greater control over data reads and writes. Although File I/O is provided as an example, other delivery mechanisms may be used between the video driver 212 and the RDP stack 220. For example, base-encoded graphical data (e.g., frames) may be communicated using named pipes or dynamic virtual channels. As another example, a direct connection (e.g., TCP connection) may be used to communicate encoded graphical data to the RDP stack 220. Any of such delivery mechanisms from the video driver 212 to the RDP stack 220 reduces resources utilization otherwise needed to perform copying and synchronization tasks. Alternatively, base-encoded graphical data may be provided directly from the video encoding manager 214, or the video encoder 240, to the RDP stack 220. For instance, communication between a video encoder 240 and RDP stack 220 may occur using a channel therebetween.

In other embodiments, an indication of base-encoded graphical data may be provided to the RDP stack 220. For example, in accordance with generating base-encoded graphical data, a texture associated therewith may be captured. In this way, a texture may be generated to represent the base-encoded graphical data. Such a texture may be stored as a shared texture, for example, in GPU or CPU. A shared texture may generally be accessed by more than one process or component (i.e., without copying the data between various memory). Thereafter, an indication of the texture representing the base-encoded graphical data may be provided to the RDP stack 220. Such a texture handle or indicator may be provided to the RDP stack 220, for example, via the video driver 212 through File I/O 280 to the RDP stack 220 (e.g. via the graphics provider 224).

In receiving the base-encoded data or an indication or representation thereof, the RDP stack 220 may perform a subsequent encoding, also referred to as a final encoding. In this regard, a final encoding may be applied to base-encoded data to generate fully-encoded data. In some cases, the final encoding includes performing data compression, as described herein.

The graphics provider 224 may obtain the base-encoded data, or an indication thereof, and provide such data to the encoder shim 252. The encoder shim 252 generally provides management or translation between the graphics provider 224 and the video encoding manager 244 or the encoding interface 254. In this way, the encoder shim 252 provides the base-encoded data, or an indication thereof, to the video encoding manager 244. To communicate with the video encoding manager 244, in some cases, the encoder shim 252 communicates via an interface, such as encoding interface 254. Encoding interface 254 facilitates a logical separation between encoder shim 212 and the video encoding manager 244, and tasks associated therewith. In some cases, the encoding interface 254 packages the base-encoded data, or indication thereof, obtained from the video driver 212 in a different manner that is suitable to the video encoding manager 244, and/or video encoder(s) 250 associated therewith. As described, the encoder shim 252 may be loaded by RDP stack 220 to manage the communication and synchronization between the video encoding manager instances (e.g., video encoding manager 214 and video encoding manager 244).

In operation, the encoder shim 252 may operate as a bridge between video encoding managers that operate in separate processes, for example, by replicating objects and maintaining coherence across the encoding workflow. Generally, the encoder shim 252 may reflect hardware and/or logical structures used in encoding, such as GPUs, monitors, and frame processors, such that encoding tasks can be distributed across different processes without loss of context or function.

The encoder shim 252 may manage session and monitor configurations. In this regard, the encoder shim 252 may create representations of GPU adapters (e.g., via adapter shims) and/or monitors (e.g., via monitor shims), reflecting the hardware setup. A virtual monitor may include its own instance of a frame processor shim, ensuring that monitor-specific frame data is correctly processed. Such components may be initialized and maintained throughout a remote session to reflect changes in the physical or virtual display configuration. As such, monitors may be treated individually while preserving alignment with the underlying hardware and/or virtual environment.

The encoder shim 252 may also facilitate creation and control of shared textures for efficient video encoding. To optimize performance, the encoder shim 252 may enable a set of shared textures to be allocated so multiple encoding tasks (such as color conversion and compression) can run in parallel. For example, while one texture is undergoing color conversion, another texture might be undergoing data compression. As such, idle time is reduced and throughput is maximized. The encoder shim 252 may also manage the lifecycle of textures, ensuring that textures are properly released when no longer needed, such as when a monitor is disconnected.

The encoder shim 252 may also facilitate synchronization across textures. As one example, a DXGI keyed mutex (e.g., a GPU-level locking mechanism) may be used to ensure only one process accesses a texture at a time. Such a process prevents conflicts and corruption during parallel processing as well as mirrors the behavior of threading locks but at the GPU level.

The encoder shim 252 may also facilitate inter-process communication to manage secure and reliable data exchange between processes. In this regard, the encoder shim 252 may manage control messages to coordinate encoding tasks. Such control messages may include metadata, such as move regions, that describe how screen contents have changed, allowing for efficient incremental encoding. Further, the encoder shim 252 may manage error handling and logging to capture critical faults, maintain detailed logs of encoding operations, and ensure any failure in the pipeline is suitably handled.

The video encoding manager 244 is generally configured to manage graphical data encoding, such as graphical data encoding performed by one or more of video encoders 250. In accordance with embodiments described herein, a final encoding, or subsequent encoding, may occur at the video encoding manager 244. At a high-level, the video encoding manager 244, and/or a video encoder(s) associated therewith, obtains base-encoded graphical data or an indication thereof (e.g., encoded via video encoding manager 214 in association with the video driver 212) and applies an encoding technique to encode the base-encoding data for more efficient transmission to a remote desktop client device. In some cases, the video encoding manager 244 may be in the form of, or use, a DLL.

In some cases, the video encoding manager 244 may determine or select a video encoder 250 to use. As shown, the video encoding manager 244 includes various video encoders 250. A video encoding manager 244 may implement, include, or use any number or type of video encoders (e.g., as needed or suitable to a desired implementation). In some cases, the video encoding manager 244 may implement a single video encoder at a single point in time. In this way, only a single video encoder is active at a single point in time. As such, the video encoding manager 244 may load and/or unload a video encoder as needed.

Video encoder(s) 250 may be any component that performs encoding of graphical data, such as base-encoded graphical data. In this way, video encoder 250 may convert graphical data from one format to another (e.g., to compress it) for storage or transmission purposes. By incorporating video encoders 250 into a video encoding manager 244 (e.g., a DLL), a developer can modularize the encoding functionality making it easier to manage and integrate into different software applications.

As described herein, a video encoder 250 operating at video encoder manager 244 in association with the RDP stack 220 may perform a final encoding or subsequent encoding. In one embodiment, a video encoder 250 is configured to compress the base-encoded data for transmitting fully-encoded data to the remote desktop client device. Examples of video encoders include an H264 video encoder, an H265 video encoder, an HDR video encoder, and a UMRDP video encoder. An H264 video encoder generally compresses graphical data using the H.264 (also referred to as Advanced Video Coding (AVC)) video compression standard, which applies various compression techniques to reduce the size of the data. An H265 video encoder generally compresses graphical data using H.265 (also referred to as High Efficiency Video Coding (HEVC)) video compression standard. An HDR video encoder generally encodes HDR content into a compressed video format. HDR refers to a technology that allows for a wider range of luminance levels and color gamut compared to standard dynamic range (SDR) content, resulting in more vibrant and lifelike images. An HDR encoder applies compression techniques to reduce the size of the HDR content while preserving its HDR characteristics. One example of an HDR encoder is H265 High Efficiency Video Coding (HEVC) HEVC444. A UMRDP encoder 240N generally refers to an encoder in association with UMRDP. Various alternative or additional video encoders may be used to provide options for adjusting compression levels, bitrates, resolution, and other parameters to optimize the encoding process for specific use cases.

Generally, graphical data is typically encoded using video compression techniques, such as Remote FX or H.264. As such, the video encoders described herein generally encode using video compression techniques. Such compression algorithms reduce the size of the graphical data for efficient transmission over the network, thereby optimizing performance and responsiveness during remote desktop sessions. In some cases, however, it may be desirable to convert the graphical output into a text-based representation. For example, character encoding for transmitting textual data and control messages may be performed. As such, an encoding process may, in some cases, encode the graphical data into a sequence of characters using a specific character encoding (e.g., UTF-8). Text-based characters can be used to represent graphical elements, including lines, boxes, and symbols. The remote desktop client display can interpret the encoded characters and display them on the screen. For example, the remote desktop client device may map the encoded graphical elements back to their visual representations. The remote desktop client’s display capabilities may determine how accurately the original graphics are represented.

To perform encoding, such as data compression, in some cases, the video encoder 250 obtains the base-encoded graphical data (e.g., encoded by video encoder 240 associated with the video driver 212). In other cases, the video encoder 250 may obtain an indication of the base-encoded graphical data. For example, the video encoder 250 may obtain a texture handle that references a texture (e.g., stored in GPU) that represents base-encoded graphical data. Using the texture handle, the video encoder 250 may reference or access the base-encoded graphical data to perform a subsequent encoding, such as data compression of the base-encoded graphical data to generate fully-encoded graphical data.

In accordance with performing a final encoding, the RDP stack 220 provides the fully-encoded graphical data to the remote desktop client device, such as remote desktop client device 102. For example, the graphics provider 224 or transport 222 may obtain the fully-encoded data and provide the data to the remote desktop client device. The remote desktop client device receives the fully-encoded graphical data (e.g., frames), decodes the data, and presents via a display of the remote desktop client device.

### Exemplary Implementations for Facilitating Distributed Video Encoding in a Remote Desktop Environment

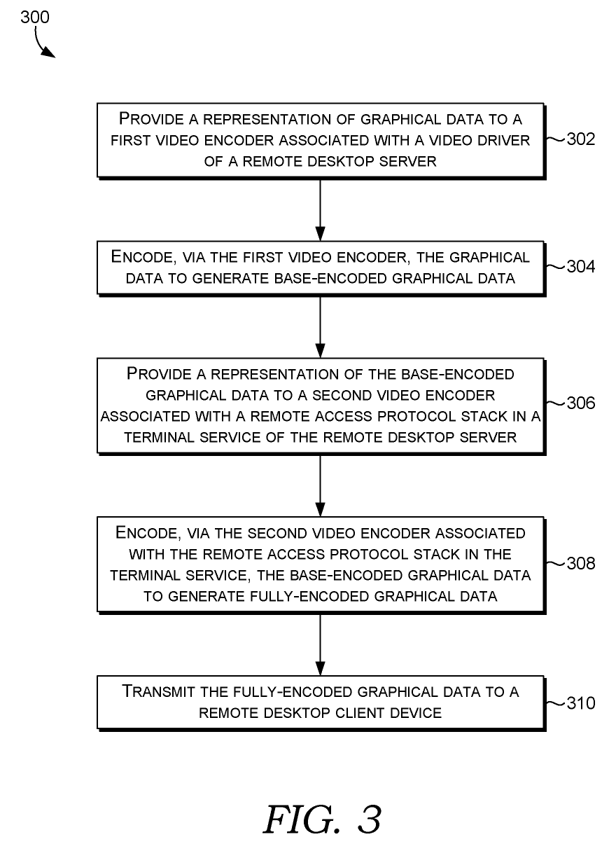

As described, various implementations can be used in accordance with embodiments described herein. FIGS. 3-4, FIGS. 3-5 provide example methods of facilitating distributed video encoding in a remote desktop environment. Methods 300, 400, and 500 can be performed by a computer device, such as device 600 described below. The flow diagrams represented in FIGS. 3-5 are intended to be exemplary in nature and not limiting.

Turning initially to method 300 of FIG. 3, method 300 is directed to facilitating distributed encoding in a remote desktop environment, in accordance with embodiments of the present technology. Initially, at block 302, a representation of graphical data is provided to a first video encoder associated with a video driver of a remote desktop server. Graphical data may be data rendered by a GPU or a CPU based on an instruction provided by the video driver. A representation of graphical data may include the graphical data itself or an indication of the graphical data, such as a texture handle.

At block 304, the graphical data is encoded via a first video encoder to generate base-encoded graphical data. In one embodiment, the first video encoder may be configured to perform preprocess of data prior to the data being compressed. As one example, the first video encoder may be a color-conversion encoder that converts data from one color format or color space to another color format or color space.

At block 306, a representation of the base-encoded graphical data is provided to a second video encoder associated with a remote access protocol stack in a terminal service of the remote desktop server. A representation of base-encoded graphical data may include the base-encoded graphical data itself or an indication of the base-encoded graphical data, such as a reference to a textured stored in a GPU or CPU. Such a representation of base-encoded graphical data may be provided to the second video encoder via a file input/output communication channel. In some cases, an encoder shim of the remote access protocol stack may obtain the representation of the base-encoded graphical data and provide such a representation to the second video encoder.

At block 308, the base-encoded graphical data is encoded via a second video encoder associated with the remote access protocol stack in the terminal service to generate fully-encoded graphical data. In one embodiment, the second video encoder performs data compression. In some cases, the second video encoder may be loaded in association with the remote access protocol stack in the terminal server based on an indication of an environment context for a remote desktop session. In accordance with generating the fully-encoded graphical data, at block 310, the fully-encoded graphical data is transmitted to a remote desktop client device.

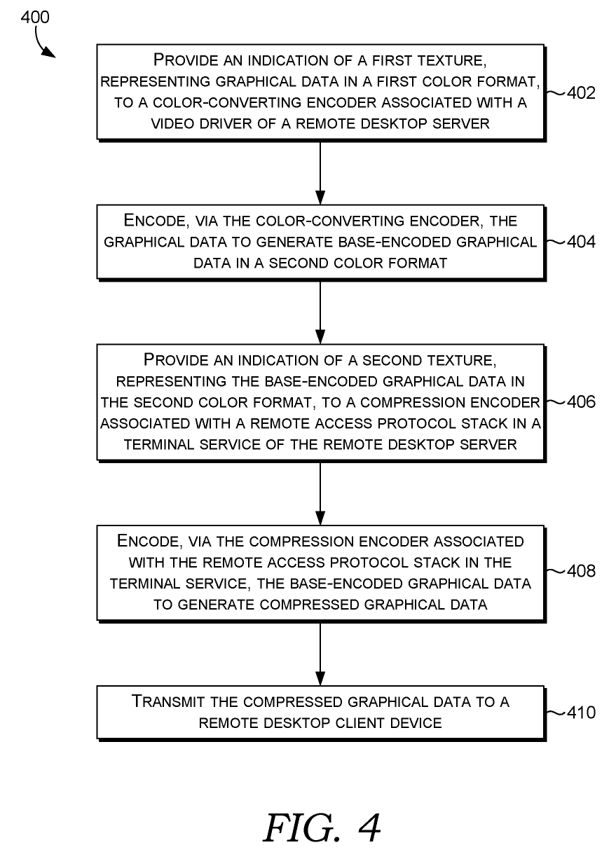

Turning to method 400 of FIG. 4, method 400 is directed to facilitating distributed encoding in a remote desktop environment, in accordance with embodiments of the present technology. Initially, at block 402, an indication of a first texture representing graphical data in a first color format is provided to a color-converting encoder associated with a video driver of a remote desktop server. In embodiments, the indication of the first texture may include a reference to the first texture stored in a GPU or a CPU.

At block 404, the graphical data is encoded via the color-converting encoder to generate base-encoded graphical data in a second color format. In this way, the graphical data is encoded in one manner in association with the video driver and/or GPU. In some cases, the color-converting encoder may be loaded in association with the video driver. Such loading may be initiated based on an indication of a direct streaming environment for a remote desktop session.

At block 406, an indication of a second texture representing the base-encoded graphical data in the second color format is provided to a compression encoder associated with a remote access protocol stack in a terminal service of the remote desktop server. In one embodiment, the indication of the second texture may be a reference to the second texture stored in a GPU or a CPU. In some cases, an encoder shim of the remote access protocol stack may obtain the indication of the second texture and provide such an indication to the compression encoder.

At block 408, the base-encoded graphical data is encoded via the compression encoder associated with the remote access protocol stack to generate compressed graphical data. In some cases, the compression encoder is loaded in association with the remote access protocol stack in the terminal server. Such loading may be initiated based on an indication of a direct streaming environment for a remote desktop session. Thereafter, at block 410, the compressed graphical data is transmitted to a remote desktop client device.

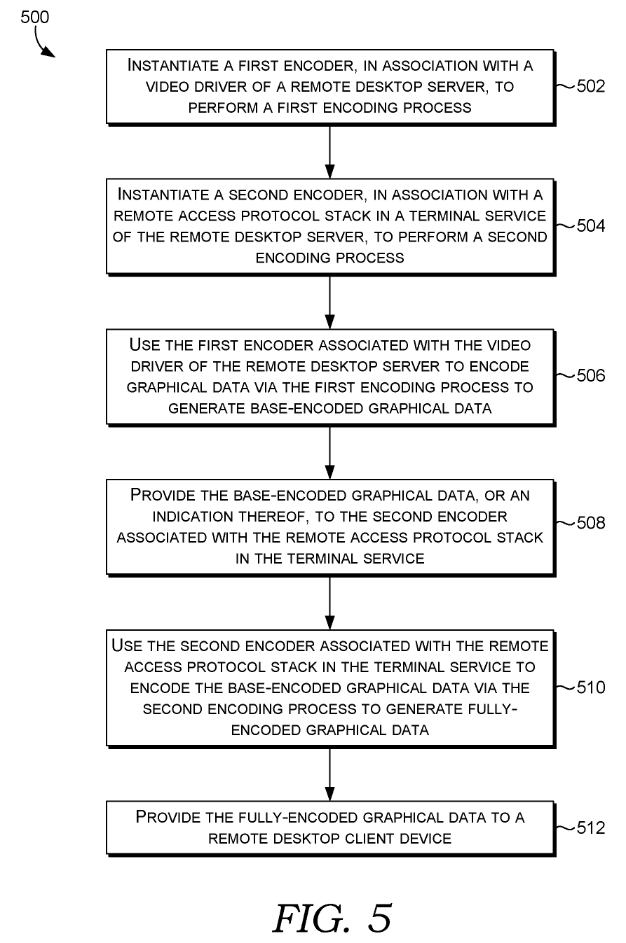

Turning to method 500 of FIG. 5, method 500 is directed to facilitating distributed encoding in a remote desktop environment, in accordance with embodiments of the present technology. Initially, at block 502, a first encoder is instantiated in association with a video driver of a remote desktop server to perform a first encoding process. In some embodiments, the first encoder is instantiated based on obtaining an indication to use distributed encoding or based on a particular environment context (e.g., direct streaming).

At block 504, a second encoder is instantiated in association with a remote access protocol stack in a terminal service of the remote desktop server to perform a second encoding process. In some embodiments, the second encoder is instantiated based on obtaining an indication to use distributed encoding or based on a particular environment context (e.g., direct streaming).

At block 506, the first encoder associated with the video driver is used to encode graphical data via the first encoding process to generate base-encoded graphical data.

At block 508, the base-encoded graphical data, or an indication thereof, is provided to the second encoder associated with the remote access protocol stack in the terminal service.

Thereafter, at block 510, the second encoder associated with the remote access protocol stack in the terminal service is used to encode the base-encoded graphical data via the second encoding process to generate fully-encoded graphical data. A second encoder may be an encoder that performs data compression for communicating data to a remote desktop client device. In association with generating the fully-encoded graphical data, at block 512, the fully-encoded graphical data is provided to a remote desktop client device.

Accordingly, we have described various aspects of technology directed to systems, and methods for facilitating efficient distributed encoding in a remote desktop environment. It is understood that various features, sub-combinations, and modifications of the embodiments described herein are of utility and may be employed in other embodiments without reference to other features or sub-combinations. Moreover, the order and sequences of steps shown in the example methods 300, 400, and 500 are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computerized system, such as the computerized system described in any of the embodiments above, comprises one or more processors, and one or more computer storage media storing computer-useable instructions that, when executed by the one or more processors, cause the one or more processors to perform operations. The operations comprise providing a representation of graphical data to a first video encoder associated with a video driver of a remote desktop server. The operations may further comprise encoding, via the first video encoder, the graphical data to generate base-encoded graphical data. The operations may further comprise providing a representation of the base-encoded graphical data to a second video encoder associated with a remote access protocol stack in a terminal service of the remote desktop server. The operations may further comprise encoding, via the second video encoder associated with the remote access protocol stack in the terminal service, the base-encoded graphical data to generate fully-encoded graphical data. The operations may further comprise transmitting the fully-encoded graphical data to a remote desktop client device. In this way, embodiments of this disclosure enable an improved implementation of video encoding in a remote desktop environment. Further, in this way, embodiments, as described herein, reduce computing resources used in performing video encoding by distributing encoding across a remote desktop server.

In any combination of the above embodiments of the computerized system, the graphical data comprises data rendered by a graphics processing unit or a central processing unit based on an instruction provided by the video driver.

In any combination of the above embodiments of the computerized system, the representation of the base-encoded graphical data is provided from the video driver to the remote access protocol stack via a file input/output communication channel.

In any combination of the above embodiments of the computerized system, an encoder shim of the remote access protocol stack obtains the representation of the base-encoded graphical data and provides the representation of the base-encoded graphical data to the second video encoder.

In any combination of the above embodiments of the computerized system, the representation of the graphical data comprises a reference to a texture stored in a graphics processing unit or a central processing unit.

In any combination of the above embodiments of the computerized system, the representation of the base-encoded graphical data comprises a reference to a texture stored in a graphics processing unit or a central processing unit.

In any combination of the above embodiments of the computerized system, the first video encoder comprises an encoder that performs color conversion from a first color format to a second color format.

In any combination of the above embodiments of the computerized system, the first video encoder comprises an encoder that performs a preprocessing of the graphical data prior to data compression.

In any combination of the above embodiments of the computerized system, the second video encoder comprises an encoder that performs data compression.

In any combination of the above embodiments of the computerized system, the first video encoder is loaded in association with the video driver and the second video encoder is loaded in association with the remote access protocol stack in the terminal server based on an indication of an environment context for a remote desktop session.

In other embodiments, a computer-implemented method is provided. The method includes providing an indication of a first texture, representing graphical data in a first color format, to a color-converting encoder associated with a video driver of a remote desktop server. The method may further include encoding, via the color-converting encoder, the graphical data to generate base-encoded graphical data in a second color format. The method may further include providing an indication of a second texture, representing the base-encoded graphical data in the second color format, to a compression encoder associated with a remote access protocol stack in a terminal service of the remote desktop server. The method may further include encoding, via the compression encoder associated with the remote access protocol stack in the terminal service, the base-encoded graphical data to generate compressed graphical data. The method may further include transmitting the compressed graphical data to a remote desktop client device. In this way, embodiments of this disclosure enable an improved implementation of video encoding in a remote desktop environment. Further, in this way, embodiments, as described herein, reduce computing resources used in performing video encoding by distributing encoding across a remote desktop server.

In any combination of the above embodiments of the computer-implemented method, the indication of the first texture comprises a reference to the first texture stored in a graphics processing unit or a central processing unit.

In any combination of the above embodiments of the computer-implemented method, the indication of the second texture comprises a reference to the second texture stored in a graphics processing unit or a central processing unit.

In any combination of the above embodiments of the computer-implemented method, an encoder shim of the remote access protocol stack obtains the indication of the second texture and provides the indication of the second texture to the compression encoder associated with the remote access protocol stack in the terminal service.

In any combination of the above embodiments of the computer-implemented method, the color-converting encoder is loaded in association with the video driver and the compression encoder is loaded in association with the remote access protocol stack in the terminal server based on an indication of a direct streaming environment for a remote desktop session.

In other embodiments, one or more computer storage media having computer-executable instructions embodied thereon that, when executed by one or more processors, cause the one or more processors to perform a method is provided. The method includes instantiating a first encoder, in association with a video driver of a remote desktop server, to perform a first encoding process. The method also includes instantiating a second encoder, in association with a remote access protocol stack in a terminal service of the remote desktop server, to perform a second encoding process. The method may further use the first encoder associated with the video driver of the remote desktop server to encode graphical data via the first encoding process to generate base-encoded graphical data. The method may further includes providing the base-encoded graphical data, or an indication thereof, to the second encoder associated with the remote access protocol stack in the terminal service. The method may also use the second encoder associated with the remote access protocol stack in the terminal service to encode the base-encoded graphical data via the second encoding process to generate fully-encoded graphical data. The method may further include providing the fully-encoded graphical data to a remote desktop client device. In this way, embodiments of this disclosure enable an improved implementation of video encoding in a remote desktop environment. Further, in this way, embodiments, as described herein, reduce computing resources used in performing video encoding by distributing encoding across a remote desktop server.

In any combination of the above embodiments of the media, the indication of the base-encoded graphical data comprises a texture handle associated with a texture representing the base-encoded graphical data.

In any combination of the above embodiments of the media, the first encoder and the second encoder are instantiated based on obtaining an indication to use distributed encoding.

In any combination of the above embodiments of the media, the first encoder comprises an encoder that converts the graphical data from a first color format to a second color format.

In any combination of the above embodiments of the media, the second encoder comprises an encoder that performs data compression.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 6 in particular, an exemplary operating environment for implementing aspects of the technology described herein is shown and designated generally as computing device 600. Computing device 600 is just one example of a suitable computing environment and is not intended to suggest any limitation as to the scope of use or functionality of the technology described herein. Neither should the computing device 800 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, an illustrative power supply 622, and a radio(s) 624. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor hereof recognizes that such is the nature of the art and reiterates that the diagram of FIG. 6 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory 612 may be removable, non-removable, or a combination thereof. Exemplary memory includes solid-state memory, hard drives, and optical-disc drives. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, and vibrating component. I/O port(s) 618 allow computing device 600 to be logically coupled to other devices including I/O components 620, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 600. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include radio(s) 624. The radio 624 transmits and receives radio communications. The computing device may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. A computing system comprising:
a processor; and
computer storage memory having computer-executable instructions stored thereon which, when executed by the processor, configure the computing system to perform operations comprising:
providing a representation of graphical data to a first video encoder associated with a video driver of a remote desktop server;
encoding, via the first video encoder, the graphical data to generate base-encoded graphical data;
providing a representation of the base-encoded graphical data to a second video encoder associated with a remote access protocol stack in a terminal service of the remote desktop server;
encoding, via the second video encoder associated with the remote access protocol stack in the terminal service, the base-encoded graphical data to generate fully-encoded graphical data; and
transmitting the fully-encoded graphical data to a remote desktop client device.

2. The computing system of claim 1, wherein the graphical data comprises data rendered by a graphics processing unit or a central processing unit based on an instruction provided by the video driver.

3. The computing system of claim 1, wherein the representation of the base-encoded graphical data is provided from the video driver to the remote access protocol stack via a file input/output communication channel.

4. The computing system of claim 3, wherein an encoder shim of the remote access protocol stack obtains the representation of the base-encoded graphical data and provides the representation of the base-encoded graphical data to the second video encoder.

5. The computing system of claim 1, wherein the representation of the graphical data comprises a reference to a texture stored in a graphics processing unit or a central processing unit.

6. The computing system of claim 1, wherein the representation of the base-encoded graphical data comprises a reference to a texture stored in a graphics processing unit or a central processing unit.

7. The computing system of claim 1, wherein the first video encoder comprises an encoder that performs color conversion from a first color format to a second color format.

8. The computing system of claim 1, wherein the first video encoder comprises an encoder that performs a preprocessing of the graphical data prior to data compression.

9. The computing system of claim 1, wherein the second video encoder comprises an encoder that performs data compression.

10. The computing system of claim 1, wherein the first video encoder is loaded in association with the video driver and the second video encoder is loaded in association with the remote access protocol stack in the terminal server based on an indication of an environment context for a remote desktop session.

11. A computer-implemented method comprising:
providing an indication of a first texture, representing graphical data in a first color format, to a color-converting encoder associated with a video driver of a remote desktop server;
encoding, via the color-converting encoder, the graphical data to generate base-encoded graphical data in a second color format;
providing an indication of a second texture, representing the base-encoded graphical data in the second color format, to a compression encoder associated with a remote access protocol stack in a terminal service of the remote desktop server;
encoding, via the compression encoder associated with the remote access protocol stack in the terminal service, the base-encoded graphical data to generate compressed graphical data; and
transmitting the compressed graphical data to a remote desktop client device.

12. The method of claim 11, wherein the indication of the first texture comprises a reference to the first texture stored in a graphics processing unit or a central processing unit.

13. The method of claim 11, wherein the indication of the second texture comprises a reference to the second texture stored in a graphics processing unit or a central processing unit.

14. The method of claim 11, wherein an encoder shim of the remote access protocol stack obtains the indication of the second texture and provides the indication of the second texture to the compression encoder associated with the remote access protocol stack in the terminal service.

15. The method of claim 11, wherein the color-converting encoder is loaded in association with the video driver and the compression encoder is loaded in association with the remote access protocol stack in the terminal server based on an indication of a direct streaming environment for a remote desktop session.

16. One or more computer storage media having computer-executable instructions embodied thereon that, when executed by one or more processors, cause the one or more processors to perform a method, the method comprising:
instantiating a first encoder, in association with a video driver of a remote desktop server, to perform a first encoding process;
instantiating a second encoder, in association with a remote access protocol stack in a terminal service of the remote desktop server, to perform a second encoding process;
using the first encoder associated with the video driver of the remote desktop server to encode graphical data via the first encoding process to generate base-encoded graphical data;
providing the base-encoded graphical data, or an indication thereof, to the second encoder associated with the remote access protocol stack in the terminal service;
using the second encoder associated with the remote access protocol stack in the terminal service to encode the base-encoded graphical data via the second encoding process to generate fully-encoded graphical data; and
providing the fully-encoded graphical data to a remote desktop client device.

17. The media of claim 16, wherein the indication of the base-encoded graphical data comprises a texture handle associated with a texture representing the base-encoded graphical data.

18. The media of claim 16, wherein the first encoder and the second encoder are instantiated based on obtaining an indication to use distributed encoding.

19. The media of claim 16, wherein the first encoder comprises an encoder that converts the graphical data from a first color format to a second color format.

20. The media of claim 16, wherein the second encoder comprises an encoder that performs data compression.
